(19) United States
(12) Patent Application Publication
(10) Pub. No.: US 2018/0137959 A1
(43) Pub. Date: May 17, 2018

(54) DUST CORE AND MANUFACTURING METHOD THEREFOR

(71) Applicant: TOYOTA JIDOSHA KABUSHIKI KAISHA, Toyota-shi (JP)

(72) Inventors: Shinjiro SAIGUSA, Toyota-shi (JP); Naoki IWATA, Toyota-shi (JP); Masafumi SUZUKI, Miyoshi-shi (JP); Masaaki NISHIYAMA, Komaki-shi (JP); Jung Hwan HWANG, Nagakute-shi (JP); Masashi OHTSUBO, Nagakute-shi (JP)

(73) Assignee: TOYOTA JIDOSHA KABUSHIKI KAISHA, Toyota-shi (JP)

(21) Appl. No.: 15/794,577

(22) Filed: Oct. 26, 2017

(30) Foreign Application Priority Data
Nov. 15, 2016 (JP) 2016-222701

(51) Int. Cl. H01F 1/147; H01F 41/02; B22F 1/02

(52) U.S. Cl. CPC H01F 1/14791; H01F 41/0246; B22F 2302/20; B22F 2301/35; B22F 1/02

(57) ABSTRACT

A dust core includes: a plurality of soft magnetic particles each composed of an iron-based alloy containing aluminum, each of a surface of the plurality of soft magnetic particles being coated with an aluminum nitride film; and an aluminum oxide film with which at least the aluminum nitride films located at a surface of the dust core are entirely coated.

### INCORPORATION BY REFERENCE

The disclosure of Japanese Patent Application No. 2016-222701 filed on Nov. 15, 2016 including the specification, drawings and abstract is incorporated herein by reference in its entirety.

### BACKGROUND

### 1. Technical Field

The disclosure relates to a dust core and a manufacturing method for a dust core and, specifically, relates to a dust core composed of soft magnetic particles of which the surfaces each are coated with an aluminum nitride film, and a manufacturing method for the dust core.

### 2. Description of Related Art

A dust core that is used for a reactor for power conversion, or the like, is manufactured by compression-molding soft magnetic particles of which the surfaces each are coated with an electrical insulating film. There is known an electrical insulating film that uses an aluminum nitride film having a high thermal conductivity and a high heat resistance. A dust core described in Japanese Patent Application Publication No. 2016-58732 (JP 2016-58732 A) is composed of soft magnetic particles of which each aluminum nitride film is further coated with a low-melting glass film.

### SUMMARY

The inventors found the following inconveniences in terms of a dust core composed of soft magnetic particles of which the surfaces each are coated with an aluminum nitride film. FIG. 9 is a view for illustrating a task that the disclosure intends to solve, and is a partially cross-sectional view that shows aged deterioration of a dust core. As shown in FIG. 9, an aluminum nitride film that coats the surface of each soft magnetic particle in the dust core reacts with moisture in the atmosphere during usage, and gradually changes into an aluminum hydroxide film from its surface side. That is, as a result of aged deterioration, the thickness of the aluminum hydroxide film increases, and the thickness of the aluminum nitride film reduces. As a result, there is an inconvenience that the thermal conductivity of the dust core decreases.

The low-melting glass film described in JP 2016-58732 A is formed by mixing the low-melting glass particles with soft magnetic particles of which the surfaces each are coated with an aluminum nitride film and melting the low-melting glass particles. For this reason, the low-melting glass film described in JP 2016-58732 A is difficult to coat the entire surface of the dust core. That is, an exposed portion of the aluminum nitride film remains on the surface of the dust core. A change from the exposed portion of the aluminum nitride film to the aluminum hydroxide film progresses, and it is not possible to sufficiently suppress the above-described decrease in the thermal conductivity. The low-melting glass film described in JP 2016-58732 A is originally not intended to suppress a change from the aluminum nitride film into the aluminum hydroxide film.

The disclosure provides a dust core that is able to suppress a change from an aluminum nitride film, which coats the surface of each soft magnetic particle, into an aluminum hydroxide film, and a manufacturing method for a dust core.

A first aspect of the disclosure provides a dust core. The dust core includes: a plurality of soft magnetic particles each composed of an iron-based alloy containing aluminum, a surface of each of the plurality of soft magnetic particles being coated with an aluminum nitride film; and an aluminum oxide film with which at least the aluminum nitride films located at a surface of the dust core are entirely coated.

With the dust core according to the first aspect of the disclosure, the aluminum nitride films located at the surface of the dust core are entirely coated with the aluminum oxide film. That is, no exposed portion of the aluminum nitride films is formed on the surface of the dust core, and the aluminum nitride film is protected by the aluminum oxide film having a high water resistance. For this reason, it is possible to inhibit a change of the aluminum nitride film, with which the surface of each soft magnetic particle is coated, into the aluminum hydroxide film as a result of a reaction of the aluminum nitride film with moisture in the atmosphere during usage of the dust core.

The entire aluminum nitride film that coats each of the plurality of soft magnetic particles may be coated with the aluminum oxide film. With this configuration, it is possible to effectively inhibit a change of the aluminum nitride film into the aluminum hydroxide film.

A second aspect of the disclosure provides a manufacturing method for a dust core. The manufacturing method includes: molding a green compact by compressing a plurality of soft magnetic particles each composed of an iron-based alloy containing aluminum, a surface of each of the plurality of soft magnetic particles being coated with an aluminum nitride film; coating at least a surface of the green compact with an aluminum hydroxide film by humidifying the green compact; and changing the aluminum hydroxide film into an aluminum oxide film by annealing the green compact coated with the aluminum hydroxide film.

In the dust core manufactured by the manufacturing method for a dust core according to the second aspect of the disclosure, the aluminum nitride films located at the surface of the dust core are entirely coated with the aluminum oxide film. For this reason, it is possible to inhibit a change of the aluminum nitride film, with which the surface of each soft magnetic particle is coated, into the aluminum hydroxide film as a result of a reaction of the aluminum nitride film with moisture in the atmosphere during usage of the dust core.

A third aspect of the disclosure provides a manufacturing method for a dust core. The manufacturing method includes: coating an aluminum nitride film with an aluminum hydroxide film by humidifying a plurality of soft magnetic particles each composed of an iron-based alloy containing aluminum, a surface of each of the plurality of soft magnetic particles being coated with the aluminum nitride film; molding a green compact by compressing the plurality of soft magnetic particles each coated with the aluminum hydroxide film; and changing the aluminum hydroxide film into an aluminum oxide film by annealing the green compact coated with the aluminum hydroxide film.

In the dust core manufactured by the manufacturing method for a dust core according to the third aspect of the disclosure, the entire aluminum nitride film with which each of the soft magnetic particles is coated is coated with the aluminum oxide film. For this reason, it is possible to further inhibit a change of the aluminum nitride film, with which the surface of each soft magnetic particle is coated, into the aluminum hydroxide film as a result of a reaction of the aluminum nitride film with moisture in the atmosphere during usage of the dust core.

According to the aspects of the disclosure, it is possible to provide the dust core that is able to inhibit a change of the aluminum nitride film, with which the surface of each soft magnetic particle is coated, into the aluminum hydroxide film and the manufacturing method for the dust core.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic partially cross-sectional view of a dust core according to a first embodiment;

FIG. 2 is a flowchart that shows a manufacturing method for the dust core according to the first embodiment;

FIG. 3 is a schematic partially cross-sectional view that shows the manufacturing method for the dust core according to the first embodiment;

FIG. 4 is a flowchart that shows a manufacturing method for a dust core according to a second embodiment;

FIG. 5 is a schematic partially cross-sectional view that shows the manufacturing method for the dust core according to the second embodiment;

FIG. 6 shows graphs that illustrate a change in XPS analysis result in a manufacturing step of a dust core according to a third embodiment;

FIG. 7 shows graphs that illustrate a change in XPS analysis result before and after an accelerated test of a dust core according to a third comparative embodiment;

FIG. 8 shows graphs that illustrate a change in XPS analysis result before and after an acceleration test of the dust core according to the third embodiment; and

FIG. 9 is a view for illustrating an inconvenience that is intended to be solved by the disclosure, and is a partially cross-sectional view that shows aged deterioration of a dust core.

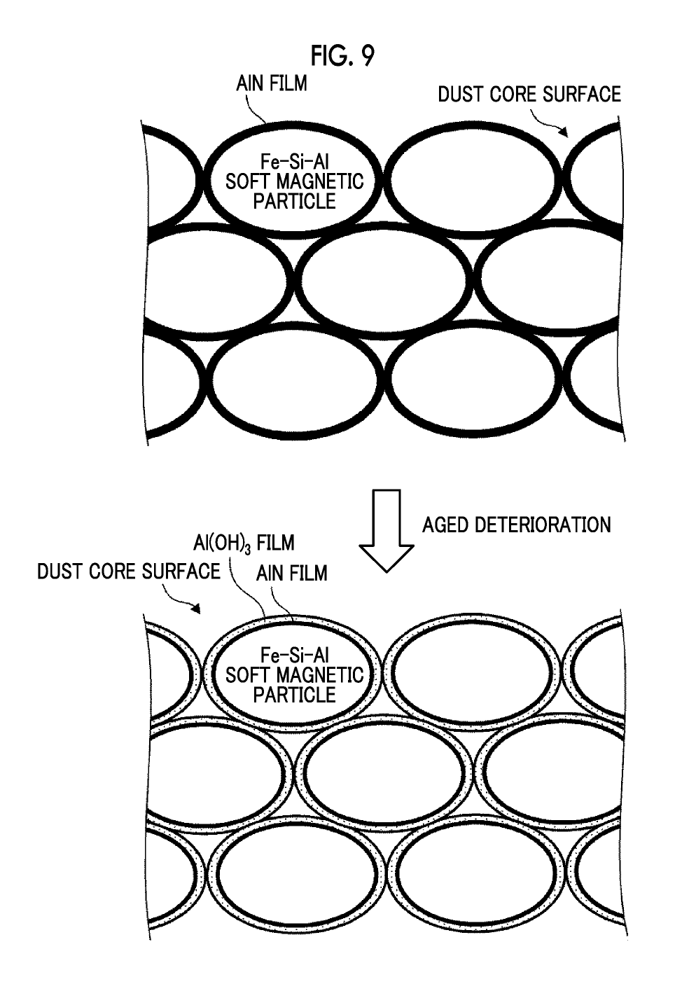

### DETAILED DESCRIPTION OF EMBODIMENTS

Hereinafter, example embodiments of the disclosure will be described in detail with reference to the accompanying drawings. However, the disclosure is not limited to the following embodiments. For the sake of clear illustration, the following description and drawings are simplified as needed.

### First Embodiment

### Composition of Dust Core According to First Embodiment

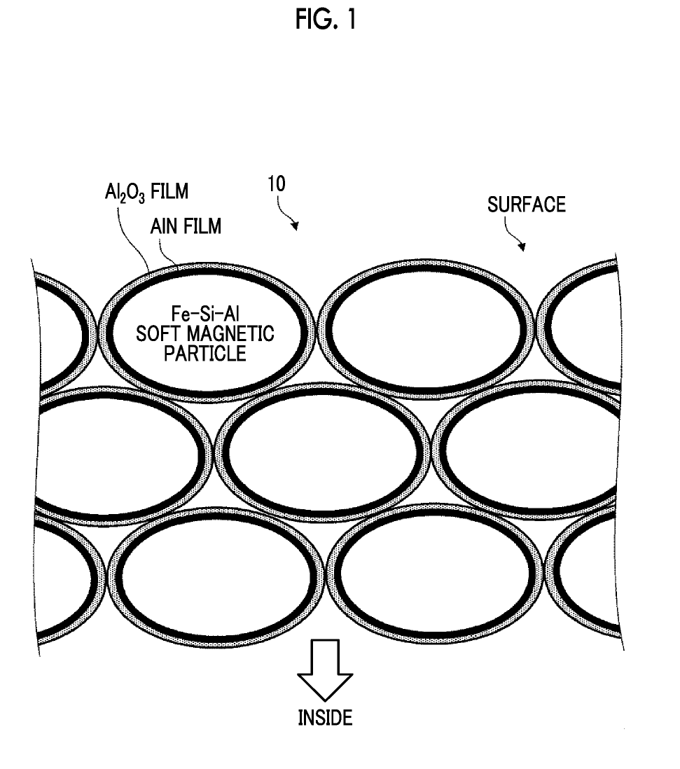

Initially, a dust core according to a first embodiment will be described with reference to FIG. 1. FIG. 1 is a schematic partially cross-sectional view of the dust core according to the first embodiment. As shown in FIG. 1, the dust core 10 according to the first embodiment is composed of a plurality of soft magnetic particles made of an Fe-based alloy containing Al.

The entire surface of each of the soft magnetic particles is coated with an aluminum nitride (AlN) film. The thickness of the AlN film is desirably 50 nm to 2 μm. The AlN film may contain Al₂O₃. Furthermore, the entire AlN film is coated with an aluminum oxide (Al₂O₃) film. The thickness of the Al₂O₃ film is 10% to 50% of the thickness of the AlN film. Specifically, the thickness of the Al₂O₃ film is desirably 20 nm to 1 μm.

Each soft magnetic particle is desirably made of an Fe—Si—Al alloy. By adding Si, it is possible to, for example, improve the magnetic permeability of the dust core (reduce a hysteresis loss) and improve the specific resistance of the dust core (reduce an eddy current loss). When Si is contained in the Fe-based alloy together with Al, it is possible to easily form the AlN film.

When the content of Si is excessive, an AlN film having a required thickness is difficult to be formed on the surface of each soft magnetic particle. For this reason, an Al ratio (Al/(Al+Si)) that is the mass ratio of Al content to the total content (Al+Si) of Al and Si is desirably higher than or equal to 0.45. The total content of Al and Si is desirably lower than or equal to 10% when the entire Fe—Si—Al alloy is 100 percentage by mass (hereinafter, simply referred to as %).

A specific composition of Al and Si in the Fe-based alloy is adjusted as needed in consideration of the productivity of AlN, the magnetic characteristic and specific resistance of the dust core, the formability of powder for a magnetic core, and the like. For example, when the entire iron-based alloy that constitutes each soft magnetic particle is 100%, Al is desirably 0.5% to 6%, and Si is desirably 0.01% to 5%.

The iron-based alloy according to the disclosure may contain one or more kinds of modified elements that can improve the productivity of AlN, the magnetic characteristic and specific resistance of the dust core, the formability of powder for a magnetic core, and the like. Examples of such modified elements may include Mn, Mo, Ti, Ni, Cr, and the like. Generally, the total amount of modified elements is desirably lower than or equal to 2%.

The particle diameter of each soft magnetic particle does not matter; however, the particle diameter of each soft magnetic particle is desirably 1 to 500 μm, and more desirably 10 to 250 μm. An excessively large particle diameter leads to a decrease in specific resistance or an increase in eddy current loss. An excessively small particle diameter leads to an increase in hysteresis loss, or the like. Therefore, it is not desirable. The particle diameter is a particle size that is determined by a screening method that classifies the particle diameter with the use of a screen having a predetermined mesh size.

The raw powder of soft magnetic particles is, for example, atomized powder formed of spherical particles. The atomized powder may be gas atomized powder that is obtained by spraying a raw material dissolved in an inert gas atmosphere, such as nitrogen gas and argon gas, or gas and water atomized powder that is obtained by spraying a dissolved raw material and then cooling the raw material.

In the dust core 10 according to the first embodiment, the entire AlN film that coats the surface of each soft magnetic particle is coated with the Al₂O₃ film. That is, no exposed portion of the AlN film is formed on the surface of each soft magnetic particle, and the AlN film is protected by the Al₂O₃ film having a high water resistance. For this reason, it is possible to inhibit a change of the AlN film into an aluminum hydroxide (Al(OH)₃) film as a result of a reaction of the AlN film with moisture in the atmosphere during usage of the dust core 10. As a result, it is possible to suppress a decrease in the thermal conductivity of the dust core 10 due to aged deterioration.

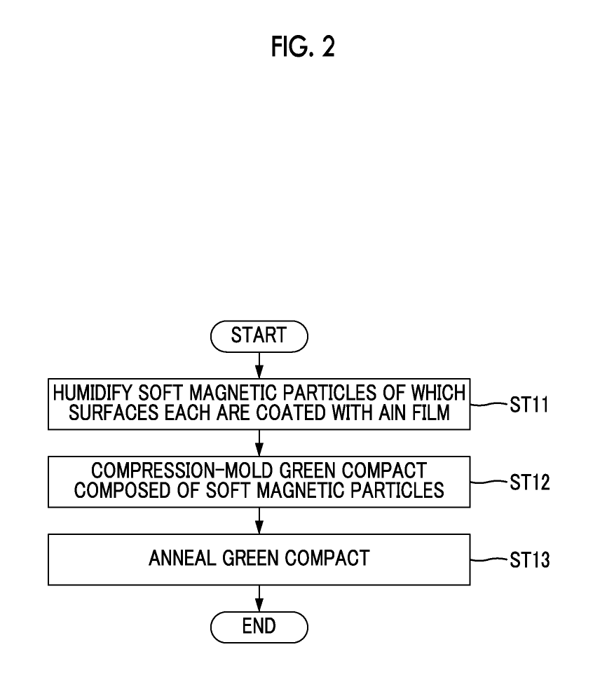

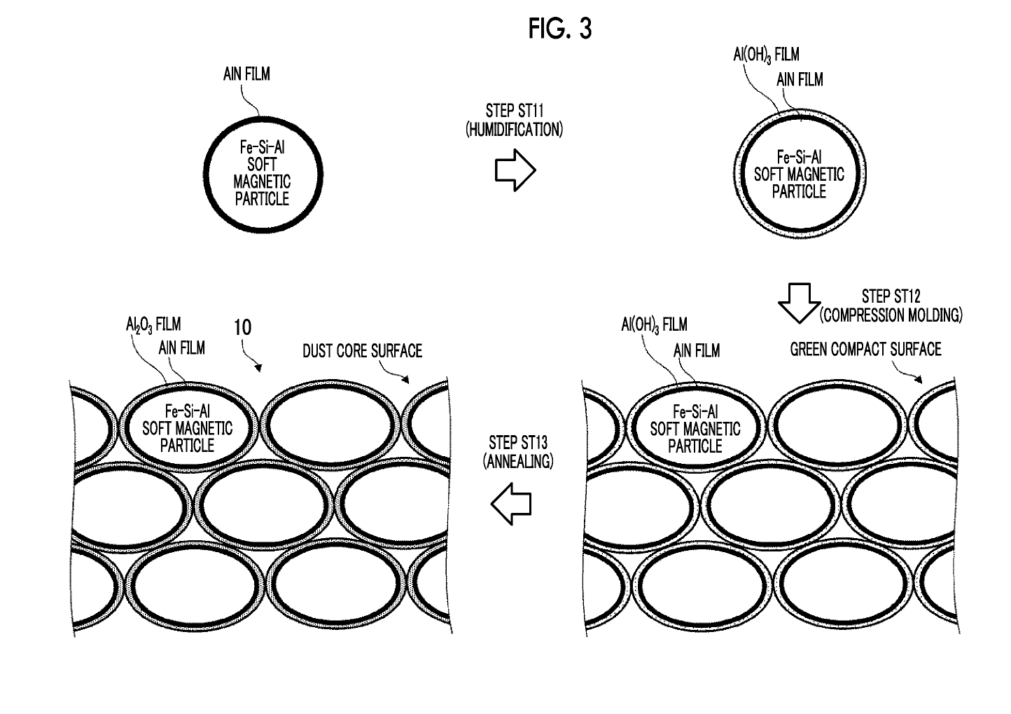

Next, a manufacturing method for the dust core according to the first embodiment will be described with reference to FIG. 2 and FIG. 3. FIG. 2 is a flowchart that shows the manufacturing method for the dust core according to the first embodiment. FIG. 3 is a schematic partially cross-sectional view that shows the manufacturing method for the dust core according to the first embodiment.

Initially, as shown in FIG. 2, soft magnetic particles of which the surfaces each are coated with an AlN film are humidified (step ST11). Thus, as shown in FIG. 3, an Al(OH)₃ film is formed on the entire surface of the AlN film that coats the surface of each soft magnetic particle. A humidification condition is desirably a humidity of 80% or higher, a temperature of 60 to 200° C. and a duration of one to ten hours.

The soft magnetic particles of which the surfaces each are coated with the AlN film are obtained by heating (nitriding) the raw material powder of soft magnetic particles at a temperature of 800 to 1300° C. in a nitrogen gas atmosphere. As described above, the AlN film may contain Al₂O₃.

Subsequently as shown in FIG. 2, a green compact is molded by charging the soft magnetic particles into a die and then compressing the soft magnetic particles (step ST12). A compression molding pressure is desirably 600 to 1800 MPa. A green compact may be molded by adding lubricant, glass having a softening temperature lower than an annealing temperature, or the like, to the soft magnetic particles.

Finally, as shown in FIG. 2, the green compact is annealed in an inert gas atmosphere, such as nitrogen gas and argon gas (step ST13). Thus, as shown in FIG. 3, the Al(OH)₃ film that coats the entire surface of each AlN film changes into an Al₂O₃ film. The annealing temperature is desirably 700 to 1300° C., and more desirably higher than or equal to 1000° C. When the annealing temperature is lower than 1000° C., a γ-Al₂O₃ film is formed. On the other hand, when the annealing temperature is higher than or equal to 1000° C., an α-Al₂O₃ film having a higher water resistance than the γ-Al₂O₃ film is formed, so it is desirable. Through the above steps, the dust core 10 according to the first embodiment is manufactured.

In the manufacturing method for the dust core according to the first embodiment, the entire AlN film that coats the surface of each soft magnetic particle is coated with the Al₂O₃ film before molding the green compact. That is, no exposed portion of the AlN film is formed on the surface of each soft magnetic particle, and the AlN film is protected by the Al₂O₃ film having a high water resistance. For this reason, it is possible to inhibit a change of the AlN film into an aluminum hydroxide (Al(OH)₃) film as a result of a reaction of the AlN film with moisture in the atmosphere during usage of the dust core 10. As a result, it is possible to suppress a decrease in the thermal conductivity of the dust core 10 due to aged deterioration.

### Second Embodiment

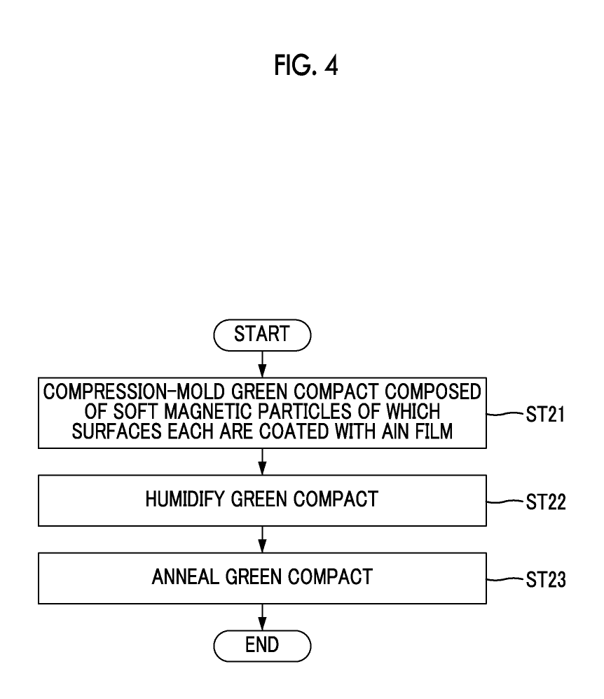

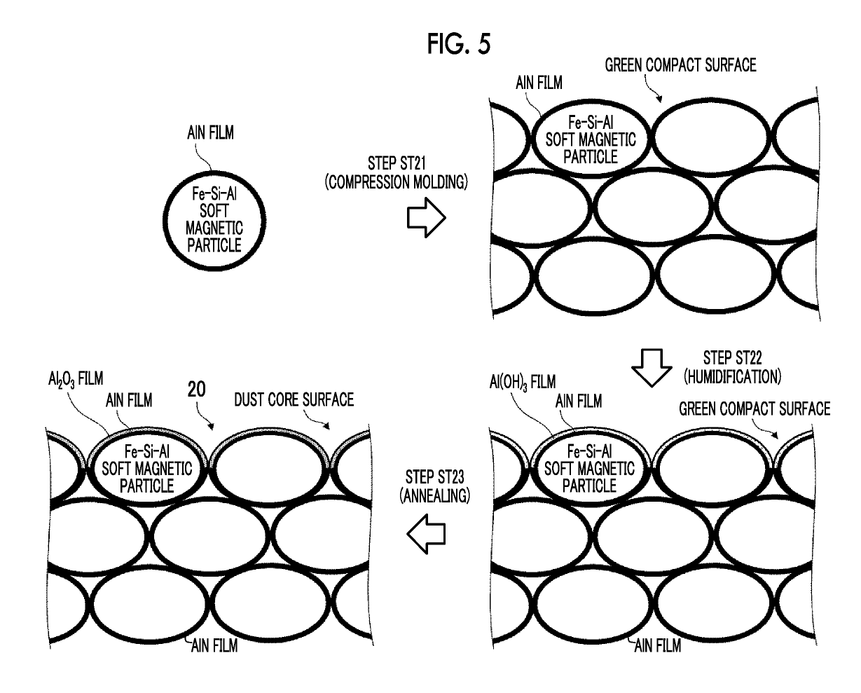

Next, a manufacturing method for a dust core according to a second embodiment will be described with reference to FIG. 4 and FIG. 5. FIG. 4 is a flowchart that shows the manufacturing method for the dust core according to the second embodiment. FIG. 5 is a schematic partially cross-sectional view that shows the manufacturing method for the dust core according to the second embodiment.

In the manufacturing method for the dust core according to the first embodiment, the entire AlN film that coats the surface of each soft magnetic particle is coated with the Al₂O₃ film before molding the green compact. In contrast, in the manufacturing method for the dust core according to the second embodiment, the AlN films located at the surface of a green compact after molding the green compact are entirely coated with an Al₂O₃ film. Hereinafter, the details will be described.

Initially, as shown in FIG. 4, a green compact is molded by charging soft magnetic particles, of which the surfaces each are coated with an AlN film, into a die and compressing the soft magnetic particles (step ST21). A compression molding pressure is the same as that of the first embodiment. As in the case of the first embodiment, the green compact may be molded by adding lubricant, glass having a softening temperature lower than an annealing temperature, or the like, to the soft magnetic particles.

Subsequently, as shown in FIG. 4, the green compact is humidified (step ST22). Thus, as shown in FIG. 5, an Al(OH)₃ film is entirely formed on at least the surfaces of the AlN films located at the surface of the green compact. A humidification condition is the same as that of the first embodiment. Of course, the Al(OH)₃ film may be formed not only on the AlN films located at the surface of the green compact but also the surfaces of the AlN films located inside the green compact.

Finally, as shown in FIG. 4, the green compact is annealed in an inert gas atmosphere, such as nitrogen gas and argon gas (step ST23). Thus, as shown in FIG. 5, the Al(OH)₃ film that coats the surfaces of the AlN films changes into an Al₂O₃ film. An annealing temperature is the same as that of the first embodiment. Through the above steps, the dust core 20 according to the second embodiment is manufactured.

In the manufacturing method for the dust core according to the second embodiment, the AlN films located at the surface of the green compact are entirely coated with the Al₂O₃ film after molding the green compact. That is, no exposed portion of the AlN film is formed on the surface of the green compact, and the AlN films are protected by the Al₂O₃ film having a high water resistance. For this reason, it is possible to inhibit a change of the AlN film into an aluminum hydroxide (Al(OH)₃) film as a result of a reaction of the AlN film with moisture in the atmosphere during usage of the dust core 20. As a result, it is possible to suppress a decrease in the thermal conductivity of the dust core 20 due to aged deterioration.

Hereinafter, the dust core and the manufacturing method therefor according to the first embodiment will be described in detail with examples and comparative examples. However, the dust core and the manufacturing method therefor according to the first embodiment are not limited to only the following examples. Table 1 shows the test conditions and results of all Examples 1 to 8 and Comparative Examples 1 to 4 according to the first embodiment. Initially, the test conditions will be described sequentially from Example 1.

TABLE 1

| | | | | | | | | AlN Reduction |
|---|---|---|---|---|---|---|---|---|
| | | | Nitriding | | Molding | Annealing | Specific | Rate (on N |
| | | Composition | Temperature | | Pressure | Temperature | Resistance | Content Basis) |
| | No. | [% by Mass] | [° C.] | Humidification | [MPa] | [° C.] | [μΩ · m] | [% by Mass] |
| Example | 1 | Fe—2%Si—3%Al | 1000 | Applied | 1000 | 750 | ≥10⁵ | 3.1 |
| | 2 | | | | | 1050 | ≥10⁵ | 2.5 |
| | 3 | | 1100 | | | 750 | ≥10⁵ | 3.3 |
| | 4 | | | | | 1050 | ≥10⁵ | 2.4 |
| | 5 | Fe—1%Si—3%Al | 1000 | | | 750 | ≥10⁵ | 3.0 |
| | 6 | | | | | 1050 | ≥10⁵ | 1.9 |
| | 7 | | 1100 | | | 750 | ≥10⁵ | 3.4 |
| | 8 | | | | | 1050 | ≥10⁵ | 1.6 |
| Comparative | 1 | Fe—2%Si—3%Al | 1000 | Not Applied | 1000 | 750 | ≥10⁵ | 51 |
| Example | 2 | | | | | 1050 | ≥10⁵ | 46 |
| | 3 | | 1100 | | | 750 | ≥10⁵ | 50 |
| | 4 | | | | | 1050 | ≥10⁵ | 51 |

### Example 1

Initially, with Example 1, the AlN film was formed on the surface by nitriding the raw material powder of soft magnetic particles having a composition of Fe-2% Si-3% Al at 1000° C. for five hours in the nitrogen gas atmosphere. Subsequently, in order to form an Al(OH)₃ film on the entire surface of each AlN film, the soft magnetic particles were humidified at a humidity of 85% and a temperature of 85° C. for five hours (step ST11 shown in FIG. 2). Subsequently, a green compact was molded by charging the soft magnetic particles into the die and compressing the soft magnetic particles at 1000 MPa (step ST12 in FIG. 2). Finally, in order to change the Al(OH)₃ film into an Al₂O₃ film, the green compact was annealed at 750° C. for 0.5 hours in the argon gas atmosphere (step ST13 in FIG. 2).

The nitrogen content of the dust core obtained through the above-described steps was analyzed with the use of an oxygen, nitrogen and hydrogen (ONH) analyzer. In addition, the dust core was subjected to an accelerated test in which the dust core is accommodated inside a constant temperature and humidity tank at a humidity of 85%, a temperature of 85° C. for 1000 hours. The nitrogen content of the dust core after the accelerated test was analyzed with the use of the ONH analyzer, and the specific resistance of the dust core was measured by a four-terminal method. An AlN reduction rate was calculated from the nitrogen content before and after the accelerated test.

### Example 2

The dust core according to Example 2 was obtained as in the case of Example 1 except that the annealing temperature was set to 1050° C.

The dust core according to Example 3 was obtained as in the case of Example 1 except that the nitriding temperature was set to 1100° C. As for the dust core according to Example 3, the surfaces of the soft magnetic particles before and after humidification were analyzed by X-ray photoelectron spectroscopy (XPS). The surface of the dust core before and after the accelerated test was also analyzed by XPS. Furthermore, the thermal conductivity of the dust core according to Example 3 after the accelerated test was measured by laser flash method.

The dust core according to Example 4 was obtained as in the case of Example 3 except that the annealing temperature was set to 1050° C.

The dust core according to Example 5 was obtained as in the case of Example 1 except that the composition of each soft magnetic particle was Fe-1% Si-3% Al.

The dust core according to Example 6 was obtained as in the case of Example 5 except that the annealing temperature was set to 1050° C.

The dust core according to Example 7 was obtained as in the case of Example 5 except that the nitriding temperature was set to 1100° C.

The dust core according to Example 8 was obtained as in the case of Example 7 except that the annealing temperature was set to 1050° C.

With Comparative Example 1, initially, the AlN film was formed on the surface by nitriding the raw material powder of soft magnetic particles having a composition of Fe-2% Si-3% Al at 1000° C. for five hours in the nitrogen gas atmosphere. Subsequently, a green compact was molded by charging the soft magnetic particles into the die and compressing the soft magnetic particles at 1000 MPa. Finally, the green compact was annealed at 750° C. for 0.5 hours in the argon gas atmosphere. That is, the dust core according to Comparative Example 1 was obtained as in the case of Example 1 except that no humidification was performed.

The dust core according to Comparative Example 2 was obtained as in the case of Example 2 except that no humidification was performed.

The dust core according to Comparative Example 3 was obtained as in the case of Example 3 except that no humidification was performed. As for the dust core according to Comparative Example 3, the surface of the dust core before and after the accelerated test was analyzed by XPS. Furthermore, the thermal conductivity of the dust core according to Comparative Example 3 after the accelerated test was measured by laser flash method.

The dust core according to Comparative Example 4 was obtained as in the case of Example 4 except that no humidification was performed.

Next, the test results will be described. As shown in Table 1, there were no differences between all the specific resistances of the dust cores according to Examples 1 to 8 and all the specific resistances of the dust cores according to Comparative Examples 1 to 4, and any of the dust cores had a favorable specific resistance. On the other hand, as shown in Table 1, the AlN reduction rate of each of the dust cores according to Comparative Examples 1 to 4 was about 50%. In contrast, the AlN reduction rate of each of the dust cores according to Examples 1 to 8 was lower than or equal to 5%. That is, it is presumable that a change from AlN into Al(OH)₃ was dramatically inhibited. The thermal conductivity of the dust core according to Comparative Example 3 after the accelerated test was 10.2 W/m·k. In contrast, the thermal conductivity of the dust core according to Example 3 after the accelerated test was 14.3 W/m·k, and improved as compared to Comparative Example 3.

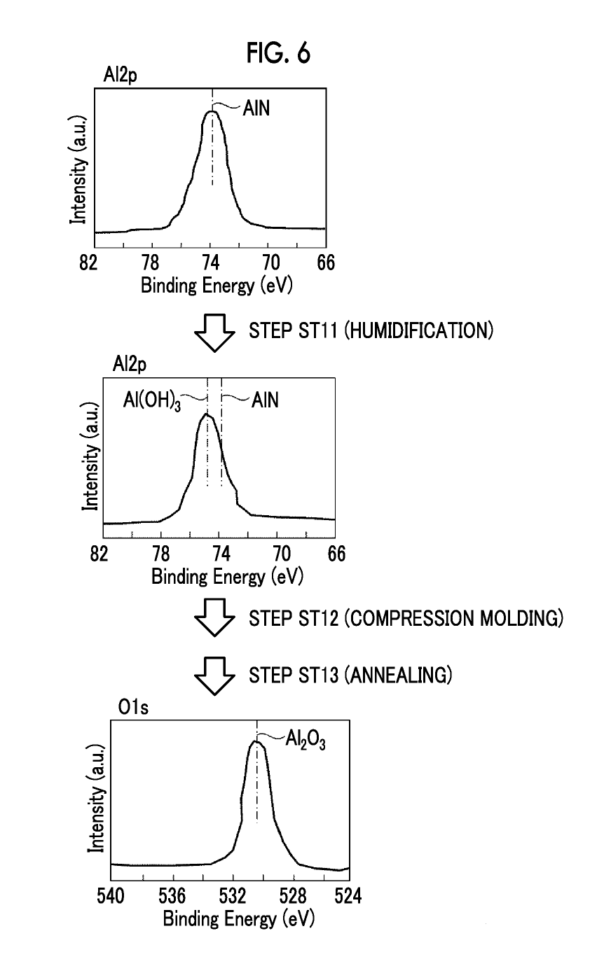

Next, a change of a surface state in a manufacturing step for a dust core will be described with reference to FIG. 6. FIG. 6 shows graphs that illustrate a change in XPS analysis result in the manufacturing step for the dust core according to Example 3. In each of the three graphs, the abscissa axis represents binding energy, and the ordinate axis represents photoelectron intensity. The upper graph and the middle graph are Al2p spectra, and the lower graph is an O1s spectrum.

As shown in FIG. 6, before humidification (step ST11), AlN was identified on the surface of each soft magnetic particle. On the other hand, after humidification (step ST11), Al(OH)₃ was identified on the surface of each soft magnetic particle instead of AlN. Therefore, it is presumable that the surface of each AlN film was changed into the Al(OH)₃ film through humidification. Al₂O₃ was identified instead of Al(OH)₃ after annealing (step ST13), that is, on the surface of the manufactured dust core. Therefore, it is presumable that the Al(OH)₃ film changed into the Al₂O₃ film through annealing.

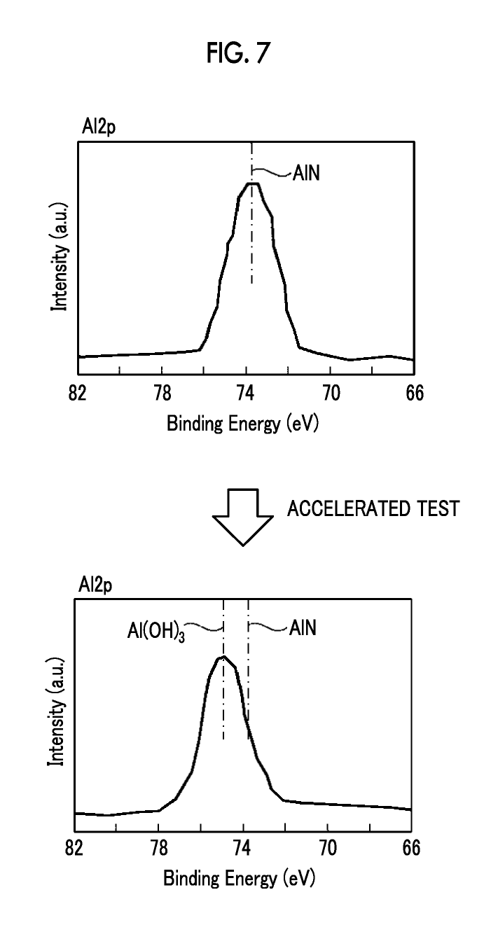

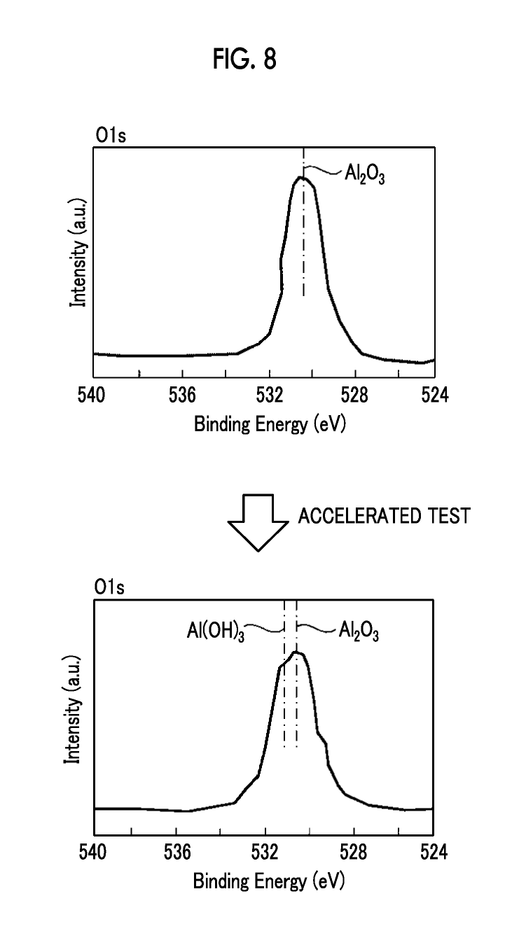

Next, a change of the surface state through the accelerated test of the manufactured dust cores will be described with reference to FIG. 7 and FIG. 8. FIG. 7 shows graphs that illustrate a change in XPS analysis result before and after the accelerated test of the dust core according to Comparative Example 3. FIG. 8 shows graphs that illustrate a change in XPS analysis result before and after the accelerated test of the dust core according to Example 3. In FIG. 7 and FIG. 8, the abscissa axis of each of the two graphs represents binding energy, and the ordinate axis represents photoelectron intensity. The upper graph and the lower graph of FIG. 7 are Al2p spectra. The upper graph of FIG. 8 is an Al2p spectrum, and the lower graph is an O1s spectrum.

As shown in FIG. 7, AlN was identified on the surface of the dust core according to Comparative Example 3 before the accelerated test. On the other hand, Al(OH)₃ was identified on the surface of the dust core after the accelerated test. Therefore, it is presumable that the surface of each AlN film was changed into the Al(OH)₃ film through the accelerated test.

As shown in FIG. 8, in the dust core according to Example 3, Al₂O₃ was identified on the surface of the dust core before the accelerated test and after the accelerated test, and almost no Al(OH)₃ was identified after the accelerated test Therefore, it is presumable that the AlN film was protected by the Al₂O₃ film and a change from AlN into Al(OH)₃ through the accelerated test was inhibited as compared to Comparative Example 3.

From the test results of the dust cores according to Examples of the first embodiment, it is presumable that the entire AlN film that coats the surface of each soft magnetic particle is coated with the Al₂O₃ film having a high water resistance through humidification. For this reason, it is presumable that a change from the AlN film into the aluminum hydroxide (Al(OH)₃) film during usage of the dust core is inhibited, and it is possible to suppress a decrease in the thermal conductivity of the dust core due to aged deterioration.

Next, the dust core and the manufacturing method therefor according to the second embodiment will be described in detail with examples. However, the dust core and the manufacturing method therefor according to the second embodiment are not limited to only the following examples. Table 2 shows the test conditions and results of all the Examples 9 to 16 according to the second embodiment. Comparative Examples according to the second embodiment are the same as Comparative Examples according to the first embodiment. Initially, the test conditions will be described sequentially from Example 9.

TABLE 2

| | | | | | | | | AlN Reduction |
|---|---|---|---|---|---|---|---|---|
| | | | Nitriding | | Molding | Annealing | Specific | Rate (on N |
| | | Composition | Temperature | | Pressure | Temperature | Resistance | Content Basis) |
| | No. | [% by Mass] | [° C.] | Humidification | [MPa] | [° C.] | [μΩ · m] | [% by Mass] |
| Example | 9 | Fe—2%Si—3%Al | 1000 | Applied | 1000 | 750 | ≥10⁵ | 15 |
| | 10 | | | | | 1050 | ≥10⁵ | 5.4 |
| | 11 | | 1100 | | | 750 | ≥10⁵ | 11 |
| | 12 | | | | | 1050 | ≥10⁵ | 3.1 |
| | 13 | Fe—1%Si—3%Al | 1000 | | | 750 | ≥10⁵ | 14 |
| | 14 | | | | | 1050 | ≥10⁵ | 4.3 |
| | 15 | | 1100 | | | 750 | ≥10⁵ | 12 |
| | 16 | | | | | 1050 | ≥10⁵ | 3.2 |

### Example 9

Initially, the AlN film was formed on the surface by nitriding the raw material powder of soft magnetic particles having a composition of Fe-2% Si-3% Al at 1000° C. for five hours in the nitrogen gas atmosphere. Subsequently, a green compact was molded by charging the soft magnetic particles into the die and compressing the soft magnetic particles at 1000 MPa (step ST21 in FIG. 4). Subsequently, in order to form the Al(OH)₃ film entirely on the surfaces of the AlN films located at the surface of the green compact, the soft magnetic particles were humidified at a humidity of 85% and a temperature of 85° C. for five hours (step ST22 in FIG. 4). Finally, in order to change the Al(OH)₃ film into an Al₂O₃ film, the green compact was annealed at 750° C. for 0.5 hours in the argon gas atmosphere (step ST23 in FIG. 4).

With Example 9, the nitrogen content of the dust core obtained through the above-described steps was analyzed with the use of the ONH analyzer. In addition, the dust core was subjected to an accelerated test in which the dust core is accommodated inside a constant temperature and humidity tank at a humidity of 85%, a temperature of 85° C. for 1000 hours. The nitrogen content of the dust core after the accelerated test was analyzed with the use of the ONH analyzer, and the specific resistance of the dust core was measured by a four-terminal method. An AlN reduction rate was calculated from the nitrogen content before and after the accelerated test.

That is, in the above-descried Example 1, the entire AlN film that coats the surface of each soft magnetic particle was coated with the Al₂O₃ film before molding the green compact; whereas, in Example 9, the AlN films located at the surface of the green compact were entirely coated with the Al₂O₃ film after molding the green compact. The other conditions are the same between Example 1 and Example 9. That is, Example 9 corresponds to Example 1 according to the first embodiment.

The dust core according to Example 10 was obtained as in the case of Example 9 except that the annealing temperature was set to 1050° C. Example 10 corresponds to Example 2 according to the first embodiment.

The dust core according to Example 11 was obtained as in the case of Example 9 except that the nitriding temperature was set to 1100° C. Example 11 corresponds to Example 3 according to the first embodiment.

The dust core according to Example 12 was obtained as in the case of Example 11 except that the annealing temperature was set to 1050° C. Example 12 corresponds to Example 4 according to the first embodiment.

The dust core according to Example 13 was obtained as in the case of Example 9 except that the composition of each soft magnetic particle was Fe-1% Si-3% Al. Example 13 corresponds to Example 5 according to the first embodiment.

The dust core according to Example 14 was obtained as in the case of Example 13 except that the annealing temperature was set to 1050° C. Example 14 corresponds to Example 6 according to the first embodiment.

The dust core according to Example 15 was obtained as in the case of Example 13 except that the nitriding temperature was set to 1100° C. Example 15 corresponds to Example 7 according to the first embodiment.

The dust core according to Example 16 was obtained as in the case of Example 15 except that the annealing temperature was set to 1050° C. Example 16 corresponds to Example 8 according to the first embodiment.

Next, the test results will be described. There were no differences between all the specific resistances of the dust cores according to Examples 9 to 16 shown in Table 2 and all the specific resistances of the dust cores according to Comparative Examples 1 to 4 shown in Table 1, and any of the dust cores had a favorable specific resistance. On the other hand, the AlN reduction rate of each of the dust cores according to Comparative Examples 1 to 4 shown in Table 1 was about 50%. In contrast, the AlN reduction rate of each of the dust cores according to Examples 9 to 16 shown in Table 2 was lower than or equal to 15%. That is, it is presumable that a change from AlN into Al(OH)₃ was inhibited.

The AlN reduction rate (lower than or equal to 15%) of each of the dust cores according to Examples 9 to 16 of the second embodiment was higher than the AlN reduction rate (lower than or equal to 5%) of each of the dust cores according to Examples 1 to 8 of the first embodiment. Therefore, a change of the AlN film into the Al(OH)₃ film was inhibited more effectively in the first embodiment in which the entire AlN film that coats the surface of each soft magnetic particle is coated with the Al₂O₃ film before molding the green compact than in the second embodiment in which the AlN films located at the surface of the green compact are entirely coated with the Al₂O₃ film after molding the green compact.

The disclosure is not limited to the above-described embodiments. The embodiments may be modified as needed without departing from the scope of the disclosure.

What is claimed is:

1. A dust core comprising:
a plurality of soft magnetic particles each composed of an iron-based alloy containing aluminum, a surface of each of the plurality of soft magnetic particles being coated with an aluminum nitride film; and
an aluminum oxide film with which at least the aluminum nitride films located at a surface of the dust core are entirely coated.

2. The dust core according to claim 1, wherein
the entire aluminum nitride film that coats each of the plurality of soft magnetic particles is coated with the aluminum oxide film.

3. A manufacturing method for a dust core, the manufacturing method comprising:
molding a green compact by compressing a plurality of soft magnetic particles each composed of an iron-based alloy containing aluminum, a surface of each of the plurality of soft magnetic particles being coated with an aluminum nitride film;
coating at least a surface of the green compact with an aluminum hydroxide film by humidifying the green compact; and
changing the aluminum hydroxide film into an aluminum oxide film by annealing the green compact coated with the aluminum hydroxide film.

4. A manufacturing method for a dust core, the manufacturing method comprising:
coating an aluminum nitride film with an aluminum hydroxide film by humidifying a plurality of soft magnetic particles each composed of an iron-based alloy containing aluminum, a surface of each of the plurality of soft magnetic particles being coated with the aluminum nitride film;
molding a green compact by compressing the plurality of soft magnetic particles each coated with the aluminum hydroxide film; and
changing each aluminum hydroxide film into an aluminum oxide film by annealing the green compact.
